(19) United States
(12) Patent Application Publication
(10) Pub. No.: US 2012/0102911 A1
(43) Pub. Date: May 3, 2012

(54) ENGINE-LOAD CONNECTION STRATEGY

(75) Inventors: David W. Dewis, North Hampton, NH (US); John D. Watson, Evergreen, CO (US)

(73) Assignee: ICR TURBINE ENGINE CORPORATION, Hampton, NH (US)

(21) Appl. No.: 13/281,725

(22) Filed: Oct. 26, 2011

Related U.S. Application Data
(60) Provisional application No. 61/406,828, filed on Oct. 26, 2010.

(51) Int. Cl. F02C 3/20; B23P 11/00

(52) U.S. Cl. 60/39.12; 29/428; 29/426.1

(57) ABSTRACT

A method is disclosed for connecting gas turbine engine gasifier components to a transmission, generator or other load. The interface of an engine gasifier module and a load module is made between one of the gasifier turbo-compressor spools and the free power turbine. This connection is between ducting components. This reduces the precision required to mate an engine module with a load module. In the case of a large vehicle, it is possible to mount an engine skid between the structural frame members of the truck cab, in the traditional engine compartment of the cab or vertically behind the cab of the truck since the engine module can be connected to the truck's transmission module via ducting between a gasifier module components and the free power turbine and ducting between the free power turbine and exhaust or recuperator.

### CROSS REFERENCE TO RELATED APPLICATION

The present application claims the benefits, under 35 U.S.C. §119(e), of U.S. Provisional Application Ser. No. 61/406,828 entitled “Engine-Load Connection Strategy” filed on Oct. 26, 2010, which is incorporated herein by reference.

### FIELD

The present invention relates generally to gas turbine engine systems and specifically to a method for connecting a gas turbine gasifier module to a transmission, generator or other load module.

### BACKGROUND

There is a growing requirement for alternate fuels for vehicle propulsion and power generation. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion and power generation. Gas turbine engines have the advantage of being highly fuel flexible and fuel tolerant. Additionally, these engines burn fuel at a lower temperature than reciprocating engines so produce substantially less NOxs per mass of fuel burned.

Vehicle engines are typically mated to their transmissions by engaging the engine's mechanical output shaft to the transmission's gearbox. When the engine-transmission system is modularized as is typically done for military vehicles such as the Abrams main battle tank and the M107 self-propelled gun, the modules are connected by lining up and engaging the engine's output shaft with the transmission module's gear box. This operation requires precision alignment which can be time consuming and, if not carried out properly, can result in damage.

There remains a need for a fuel-efficient gas turbine engine capable of operating on multiple fuel types where engines can be manufactured as modules that can 1) be rapidly connected or disconnected to the load modules for servicing or replacement and 2) be arranged such that the modules need not be coaxial.

### SUMMARY

These and other needs are addressed by the various embodiments and configurations of the present invention which are directed generally to gas turbine engine systems and specifically to a method for connecting gas turbine engine gasifier components to a transmission, generator or other load.

The system and method are particularly adapted for use as a power plant for a vehicle, especially a truck, bus or other overland vehicle. However, it will be appreciated that the present disclosure has broader applications and may be used in many different environments and applications, including as a stationary electric power module for distributed power generation.

In the present invention, it is proposed to place the interface of an engine gasifier module and a load module at the interface between one of the gasifier spools and the free power turbine. In this way the connection is between ducting components and does not rely on mating precision mechanical components such as, for example, splined couplings. This reduces the precision required to mate an engine module with a load module especially since the gasifier and load need not be coaxial. This connection strategy makes it easier to assemble power plants or replace power plant modules in the field and eliminates reliability issues relating to alignment. A further aspect of this invention is to minimize assembly and disassembly time by having the gasifier module frame mounted for ease of handling and reduction of assembly time for its integration with the vehicle.

The engine module may be mounted on a skid for ease of handling and installation. In the case of a vehicle such as for example a Class 8 truck, it is possible to mount an engine skid between the structural frame members of the truck cab, in the traditional engine compartment of the cab or vertically behind the cab of the truck since the engine module can be connected to the truck's transmission module via ducting between a gasifier module components and the free power turbine and ducting between the free power turbine and exhaust or recuperator.

Since an engine gasifier module and a load module (the load module may be a transmission for a vehicle or an electrical generator or the like) may have substantially different masses and centers of gravity, mating the modules at a duct joint rather than at a precision mechanical gear connection greatly reduces the effort and cost of manufacture, field servicing or replacement. This invention also reduces the failure rate of a power plant due to faulty alignment or damage incurred during mating of separate mechanical engine output shafts with the gearbox of a load module in the field.

In one embodiment, an apparatus is disclosed comprising a gasifier module comprising at least one turbo-compressor spool and a combustor, the at least one turbo-compressor spool comprising a compressor in mechanical communication with a turbine; a load module comprising a free power turbine and a load in mechanical communication with the free power turbine, and ducting, wherein the gasifier and load modules are fluidly connected by the ducting and wherein at least one of the following is true (a) a flow axis of the combusted working fluid output of the gasifier is transverse to a flow axis of the combusted working fluid into the free power turbine, (b) the flow axis of the combusted working fluid output of the gasifier is transverse to an axis of rotation of the free power turbine, (c) the gasifier module is located remotely from the load module, and (d) an axis of rotation of the at least one turbo-compressor spool is transverse to an axis of rotation of the free power turbine, whereby a combusted working fluid output by the gasifier module drives the free power turbine, the free power turbine in turn providing rotary power to an output power shaft in mechanical communication with the load.

In another embodiment, a gasifier module is disclosed comprising a combustor; a recuperator; and first and second turbo-compressor spools, the first turbo-compressor spool comprising a lower pressure compressor in mechanical communication with a lower pressure turbine and the second turbo-compressor spool comprising a higher pressure compressor in mechanical communication with a higher pressure turbine, the higher pressure compressor being in fluid communication with the recuperator and combustor and the combustor being in fluid communication with higher pressure turbine; wherein the lower pressure turbine is configured to be fluidly connected to a free power turbine by a duct and a flow axis of the combusted working fluid output of the gasifier is transverse to a shaft connecting the free power turbine to a gearbox, the gearbox in turn being engaged with a load; whereby an inlet gas is pressurized by the lower pressure compressor to form a lower pressure working fluid, the lower pressure working fluid is pressurized by the higher pressure compressor to form a higher pressure working fluid, the higher pressure working fluid and a fuel are combusted by the combustor to form a heated pressurized working fluid, the heated pressurized working fluid passing through the higher pressure and lower pressure turbines to drive, respectively, the higher and lower pressure turbines, and the free power turbine to drive a load mechanically connected to the free power turbine.

In yet another embodiment, a load module is disclosed comprising a free power turbine; and a load mechanically linked to the free power turbine to receive mechanical energy from the free power turbine, wherein the free power turbine is configured to be fluidly connected to a lower pressure turbine of a gasifier module by a duct and a flow axis of the combusted working fluid output of the gasifier is transverse to an axis of at least one of a transmission and an electrical generator.

In yet another embodiment, a method is disclosed comprising providing a gasifier module, the gasifier module comprising at least one turbo-compressor spool and a combustor, the at least one turbo-compressor spool comprising a compressor in mechanical communication with a turbine; providing a load module comprising a free power turbine and a load in mechanical communication with the free power turbine, and connecting ducting to, or disconnecting ducting from at least one of the gasifier and load modules, the ducting fluidly connecting the gasifier and load modules, wherein, in the absence of the ducting, substantially no energy is transferred from the gasifier module to the load module.

It is understood that a reference to a generator includes a generator or an alternator is a reference to any mechanical-to-electrical energy conversion device which may include but not be limited to a synchronous alternator such as a wound rotor alternator or a permanent magnet machine, an asynchronous alternator such as an induction alternator, a DC generator, a permanent magnet device and a switched reluctance generator.

It is also understood that a reference to a load device may be any load driven by an engine. A load may include but not be limited to a transmission, a mechanical-to-electrical conversion device, a compressor and the like.

When discussing a gas turbine engine herein, it is also understood that a reference to an engine module is the same as a reference to a gasifier module.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

The following definitions are used herein:

Co-location means that two or more items are substantially in the same location. In an engine, components are commonly understood to be co-located when the components are within a distance of no more of about 1 meter, more commonly no more than about 0.5 meters, and even more commonly of no more than about 0.25 meters of one another. If two components are not co-located relative to one another, they are deemed to be remotely located.

A drive train is the part of a vehicle or power generating machine that transmits power from the engine to the driven members, such as the wheels on a vehicle, by means of any combination of belts, fluids, gears, flywheels, electric motors, clutches, torque converters, shafts, differentials, axles and the like.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

A gasifier is that portion of a gas turbine engine that produces the energy in the form of pressurized hot gasses that can then be expanded across the free power turbine to produce energy.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

An electrical generator as used here refers to a mechanical-to-electrical energy conversion device.

An intercooler as used herein means a heat exchanger positioned between the output of a compressor of a gas turbine engine and the input to a higher pressure compressor of a gas turbine engine. Air, or in some configurations, an air-fuel mix is introduced into a gas turbine engine and its pressure is increased by passing through at least one compressor. The working fluid of the gas turbine then passes through the hot side of the intercooler and heat is removed typically by an ambient fluid such as, for example, air or water flowing through the cold side of the intercooler.

A mechanical-to-electrical energy conversion device refers an apparatus that converts mechanical energy to electrical energy or electrical energy to mechanical energy. Examples include but are not limited to a synchronous alternator such as a wound rotor alternator or a permanent magnet machine, an asynchronous alternator such as an induction alternator, a DC generator, and a switched reluctance generator.

A traction motor is a mechanical-to-electrical energy conversion device used primarily for propulsion.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

Specific power as used herein is power per unit mass (watts per kilogram).

Spool means a group of turbo machinery components on a common shaft. A turbo-compressor spool is a spool comprised of a compressor and a turbine connected by a shaft. A free power turbine spool is a spool comprised of a turbine and a turbine power output shaft.

A recuperator is a heat exchanger that transfers heat through a network of tubes, a network of ducts or walls of a matrix wherein the flow on the hot side of the heat exchanger is typically exhaust gas and the flow on cold side of the heat exchanger is typically gas (for example, air or a fuel-air mixture) entering the combustion chamber.

Located remotely as used herein means not co-located.

Thermal efficiency as used herein is shaft output power (J/s) of an engine divided by flow rate of fuel energy (J/s), wherein the fuel energy is based on the low heat value of the fuel.

A thermal energy storage module is a device that includes either a metallic heat storage element or a ceramic heat storage element with embedded electrically conductive wires. A thermal energy storage module is similar to a heat storage block but is typically smaller in size and energy storage capacity.

Transverse means not parallel as used herein.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention. In the drawings, like reference numerals refer to like, or analogous components throughout the several views.

FIG. 1 is a schematic of a representative gas turbine engine and load architecture.

FIG. 2 is a side view illustrating the points of connection within a gas turbine engine.

FIG. 3 is a plan view illustrating the points of connection within a gas turbine engine.

FIG. 4 is an exploded plan view illustrating the points of connection within a gas turbine engine.

FIG. 5 is an isometric view illustrating the points of connection within a gas turbine engine.

FIG. 6 is an exploded isometric view illustrating the points of connection within a gas turbine engine.

FIG. 7 is an exploded side view illustrating the points of connection within a gas turbine engine.

FIG. 8 is an isometric view of the points of connection between a vehicle engine module and its transmission module.

FIG. 9 is a plan view of a gas turbine engine with horizontal generator showing the points of connection between an engine module and its load module.

FIG. 10 is a front view of two nested gas turbine engines with vertical transmissions showing the visible points of connection between a dual engine module and its dual load module.

FIG. 11 is a plan view of a gas turbine engine with horizontal generator showing the points of connection between an engine module and its right-angle electrical generating module.

FIG. 12 is a front view of a gas turbine engine with vertical generator showing the points of connection between an engine module and its in-line electrical generating module.

FIG. 13 is an isometric plan view of a gasifier module and transmission module in a truck frame.

FIG. 14 is a block schematic illustrating the present invention.

FIG. 15 shows compressor and turbine axes conventions.

FIG. 16 shows a configuration of spools.

### DETAILED DESCRIPTION

Typically, a modular engine is mated with a modular transmission, modular electrical generator or other modular load by a mechanical linkage through which the main engine power is transmitted. Various mechanical linkages may be employed but they all require a certain degree of precision and cleanliness to make an effective, trouble-free connection.

In the present invention, a modular gas turbine engine gasifier section is mated with a modular transmission, electrical generator or other load device by a ducting connection between the gasifier section and the free power turbine which is preferably manufactured as part of a modular transmission, electrical generator or other load assembly under controlled conditions. With this approach, one or more main duct connections must be made to mate the engine module with the load module. The duct connections are generally mechanical flange connections which must form a pressure seal capable of sealing pressures on the order of 5 to 10 bars. The ducts themselves preferably have some flexibility which can be achieved, for example, by a short bellows section. The bellows section allows relative motion between the gasifier module and load module which can arise, for example, because of temperature changes and, in the case of a vehicle, road vibration. The bellows section preferably would include a smooth inner surface to minimize flow perturbations and excessive pressure drop.

In one configuration, a low pressure turbine outlet is connected to a free power turbine input and a free power turbine outlet is connected with a duct leading either to an exhaust outlet or a recuperator inlet. However, in general terms, the inlet to the free power turbine receives flow from the gasifier module and the outlet from the free power turbine introduces it back into the gasifier module to complete the working fluid circuit, typically by going through the hot side of a recuperator before being exhausted. The advantage of these duct connections is that the requirements for alignment precision are substantially less since the flow that passes through the duct connections is not sensitive to flow directional changes or small mis-alignments. Both of these connections can be made with well-known flange connections that use well-known sealing methods and self-aligning methods. The connections may be flexing or non- flexing connections. The ducts may typically include a flexible section such as a bellows or the like to accommodate motion between the gasifier and load modules.

The range of pressures and temperatures for typical duct connection in a current embodiment are as follows:
low pressure turbine to free power turbine
   maximum flow temperature no more than about 1,200 K (˜1,700 F)
   maximum flow pressure no more than about 500 kPa (˜75 psi)
free power turbine to exhaust or recuperator
   maximum flow temperature no more than about 850 K (˜1,070 F)
   maximum flow pressure no more than about 100 kPa (˜15 psi)

The temperatures and pressures shown above could be higher if the free power turbine was relocated within the cycle, such as for example, between the low pressure turbine and high pressure turbine.

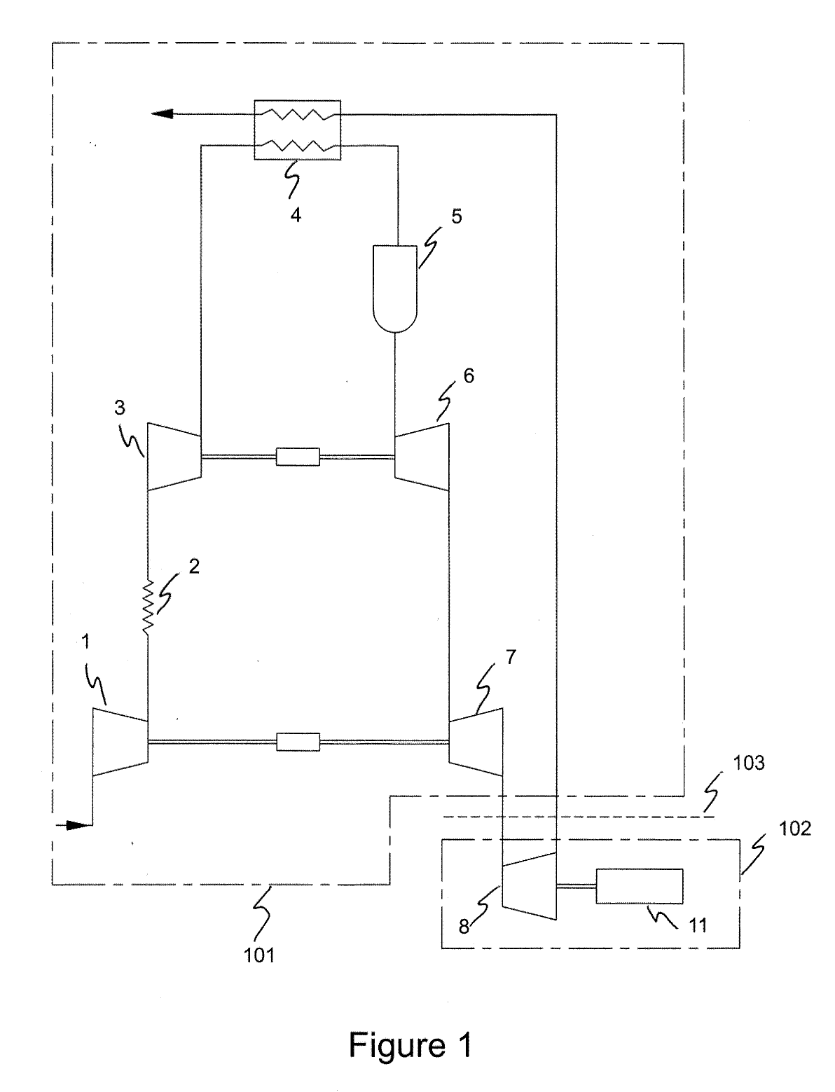

FIG. 1 is a schematic of a representative gas turbine engine and load architecture illustrating the component architecture of a typical multi-spool gas turbine engine. Gas is ingested into a low pressure compressor 1. The outlet of the low pressure compressor 1 passes through an intercooler 2 which removes a portion of heat from the gas stream at approximately constant pressure. The gas then enters a high pressure compressor 3. The outlet of high pressure compressor 3 passes through a recuperator 4 where some heat from the exhaust gas is transferred, at approximately constant pressure, to the gas flow from the high pressure compressor 3. The further heated gas from recuperator 4 is then directed to a combustor 5 where a fuel is burned, adding heat energy to the gas flow at approximately constant pressure. The gas emerging from the combustor 5 then enters a high pressure turbine 6 where work is done by the turbine to operate the high pressure compressor 3. The gas from the high pressure turbine 6 then drives a low pressure turbine 7 where work is done by the turbine to operate the low pressure compressor 1. The gas from the low pressure turbine 7 then drives a free power turbine 8. In this illustration, the shaft of the free power turbine, in turn, drives a transmission 11 which may be an electrical, mechanical or hybrid transmission for a vehicle. Alternately, the shaft of the free power turbine can drive an electrical generator or alternator. This engine design is described, for example, in U.S. patent application Ser. No. 12/115,134 filed May 5, 2008, entitled “Multi-Spool Intercooled Recuperated Gas Turbine”, which is incorporated herein by this reference.

If this power plant were to be modularized according to the present invention, then the engine or gasifier module would be denoted by boundary 101, the load module would be denoted by boundary 102 and the location of the interface between the modules would be denoted by line 103. As can be seen, the connection between free power turbine 8 and load 11 is internal to the load module. As can be appreciated, mating of an engine and load module would also involve other connections such as for example various electrical connections required for control and the like.

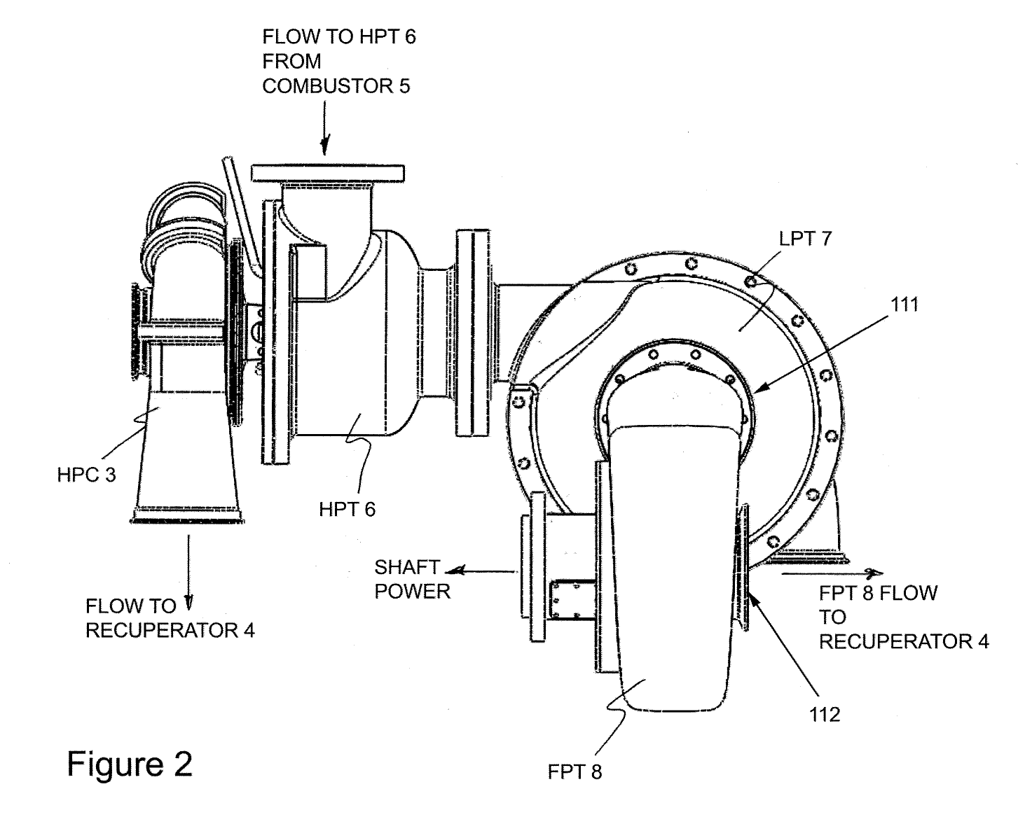

FIG. 2 is a side view illustrating various gas turbine engine components and the points of connection within a gas turbine engine. In this view, compressed flow from high pressure compressor 3 is sent to the cold side of a recuperator (not shown in this figure but illustrated in FIGS. 1, 9, 10, 11 and 12 as component 4). Flow from a combustor (not shown as it is embedded within recuperator 4) enters high pressure turbine 6, is expanded and sent to low pressure turbine 7 where it is further expanded and delivered to free power turbine 8. In this engine configuration, free power turbine 8 provides the primary mechanical shaft power of the engine. The flow from free power turbine 8 is sent to the hot side of the recuperator (not shown in this figure but illustrated in FIG. 1 as component 4). According to the present invention, the connection points between the engine module and load module may be at location 111 between the low pressure turbine 7 outlet and free power turbine 8 input and at location 112 between free power turbine 8 outlet and a duct leading to the inlet of the hot side of the recuperator. As can be appreciated, the connection points between the engine module and load module may be at different locations, such as for example between the high pressure turbine outlet and the low pressure turbine inlet and between the free power turbine outlet and a duct leading to recuperator inlet.

A system of dense packaging of turbomachinery in a gas turbine engine is disclosed in U.S. patent application Ser. No. 13/226,156 entitled “Gas Turbine Engine Configurations” filed Sep. 6, 2011 which is incorporated herein by reference. Dense-packing is possible because of a number of features of the basic engine. These features include: the use of compact centrifugal compressors and radial turbine assemblies; the close coupling of turbomachinery for a dense packaging; the ability to rotate certain key components so as to facilitate ducting and preferred placement of other components; the ability to control spool shaft rotational direction; and operation at high overall pressure ratios.

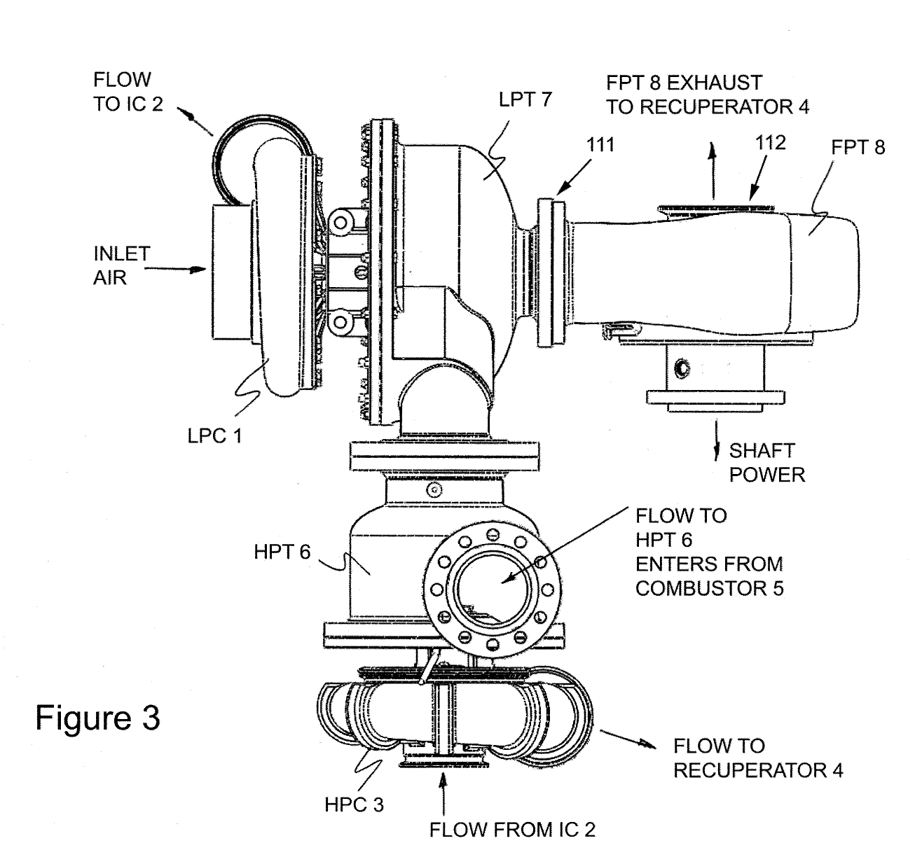

FIG. 3 is a plan view illustrating various gas turbine engine components and the points of connection within a gas turbine engine. The working fluid (air or, in some engine configurations, an air-fuel mixture) enters low pressure compressor 1 and the resulting compressed flow is sent to an intercooler (not shown in this figure but illustrated in FIG. 1 as component 2). Flow from the intercooler enters high pressure compressor 3 and the resulting further compressed flow is sent to the cold side of a recuperator (not shown in this figure but illustrated in FIG. 1 as component 4). Flow from a combustor (not shown as it is typically embedded within recuperator 4) enters high pressure turbine 6, is expanded and sent to low pressure turbine 7 where it is further expanded and delivered to free power turbine 8. In this engine configuration, free power turbine 8 provides the primary mechanical shaft power of the engine. The flow from free power turbine 8 is sent to the hot side of the recuperator (not shown in this figure but illustrated in FIG. 1 as component 4). According to the present invention, the connection points between the engine module and load module may be at location 111 between the low pressure turbine 7 outlet and free power turbine 8 input and at location 112 between free power turbine 8 outlet and a duct leading to recuperator 4 inlet. As can be appreciated, the connection points between the engine module and load module may be at different locations, such as for example between the high pressure turbine outlet and the low pressure turbine inlet and between the free power turbine outlet and a duct leading to recuperator inlet.

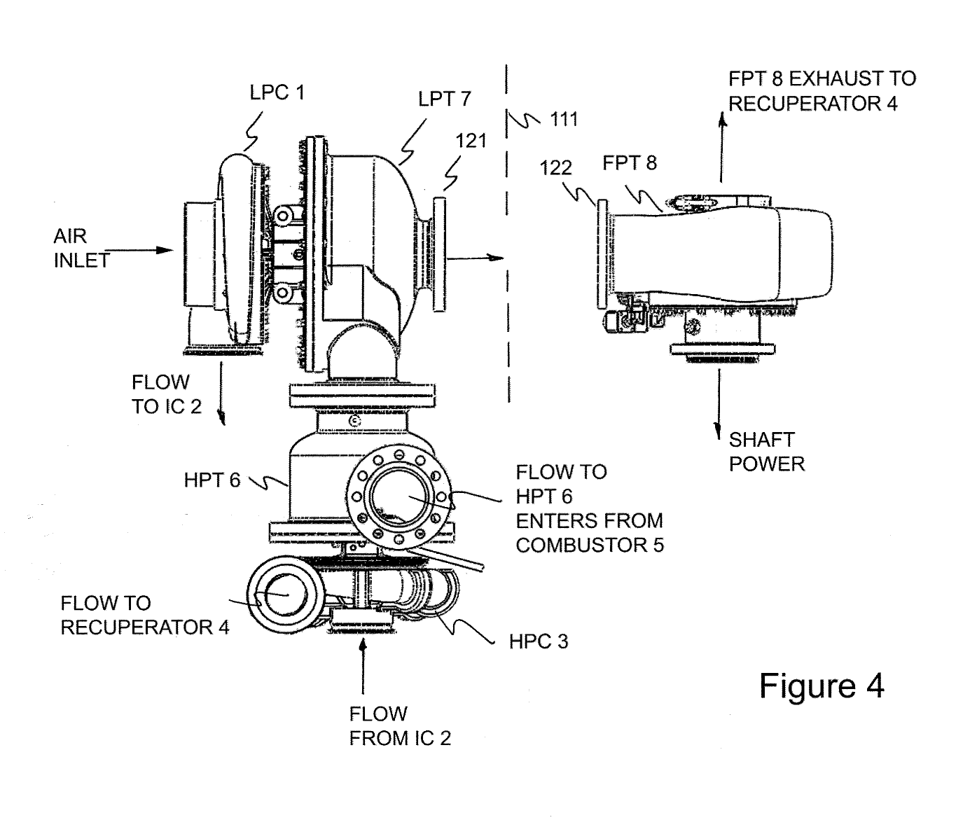

FIG. 4 is an exploded plan view illustrating the points of connection within a gas turbine engine. This figure is the same as FIG. 3 except that the high pressure compressor 3 is rotated 180 degrees relative to high pressure turbine 6. A first connection point at location 111 between the low pressure turbine 7 outlet and free power turbine 8 input is shown disconnected at output flange 121 of low pressure turbine 7 and input flange 122 of free power turbine 8. A second connection point at location 112 is between free power turbine 8 outlet and a duct leading to recuperator 4 inlet.

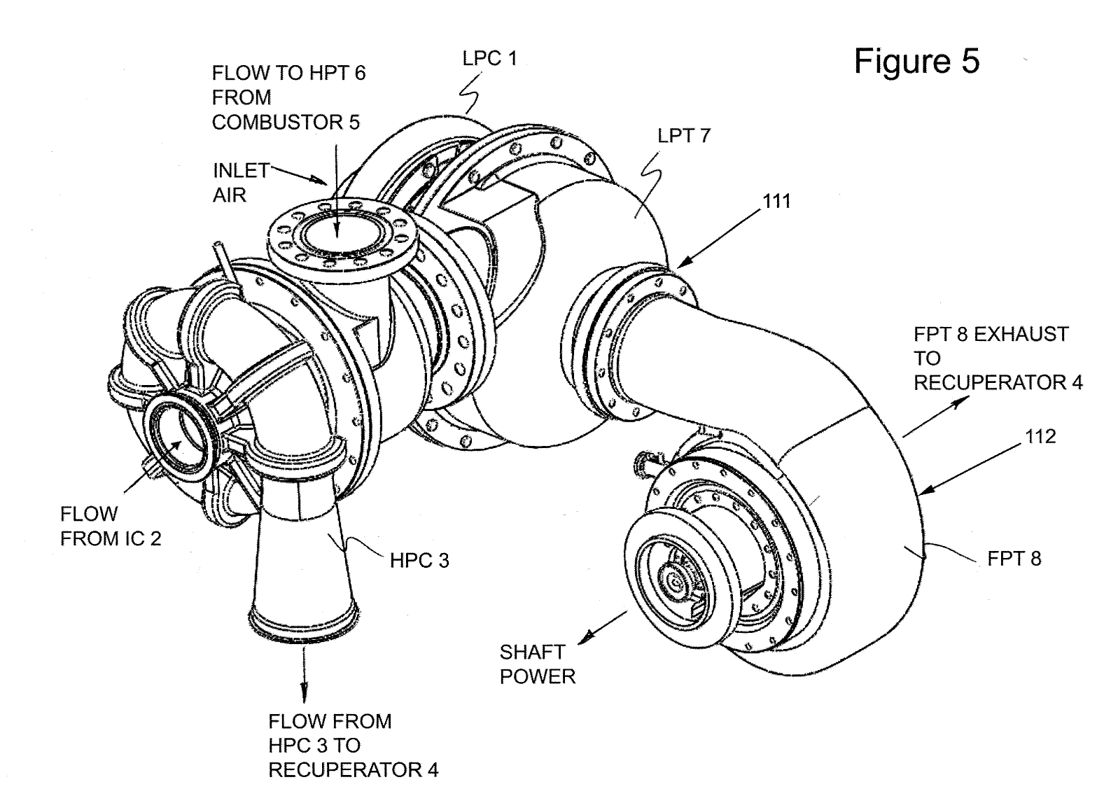

FIG. 5 is an isometric view illustrating various gas turbine engine components and the points of connection within a gas turbine engine. The working fluid (air or in some engine configurations, an air-fuel mixture) enters low pressure compressor 1 and the resulting compressed flow is sent to an intercooler (not shown in this figure but illustrated in FIG. 1 as component 2). Flow from the intercooler enters high pressure compressor 3 and the resulting further compressed flow is sent to the cold side of a recuperator (not shown in this figure but illustrated in FIG. 1 as component 4). Flow from a combustor (not shown as it is typically embedded within recuperator 4) enters high pressure turbine 6, is expanded and sent to low pressure turbine 7 where it is further expanded and delivered to free power turbine 8. In this engine configuration, free power turbine 8 provides the primary mechanical shaft power of the engine. The flow from free power turbine 8 is sent to the hot side of the recuperator (not shown in this figure but illustrated in previous figures as component 4). According to the present invention, the connection points between the engine module and load module may be at location 111 between the low pressure turbine 7 outlet, and free power turbine 8 input and at location 112 between free power turbine 8 outlet and a duct leading to recuperator 4 inlet. As can be appreciated, the connection points between the engine module and load module may be at different locations, such as for example between the high pressure turbine outlet and the low pressure turbine inlet and between the free power turbine outlet and a duct leading to recuperator inlet.

As can be seen from some of the figures, various compressor and turbine components can be rotated relative to the other components. The free power turbine can be rotated relative to the other components to vary the direction of its outlet flow to the recuperator (not shown) and the direction of the output mechanical power shaft. This flexibility allows the other major engine components (intercooler, recuperator, combustor and load device) to be positioned where they best fit the particular engine application (for example vehicle engine, stationary power engine, nested engines and the like).

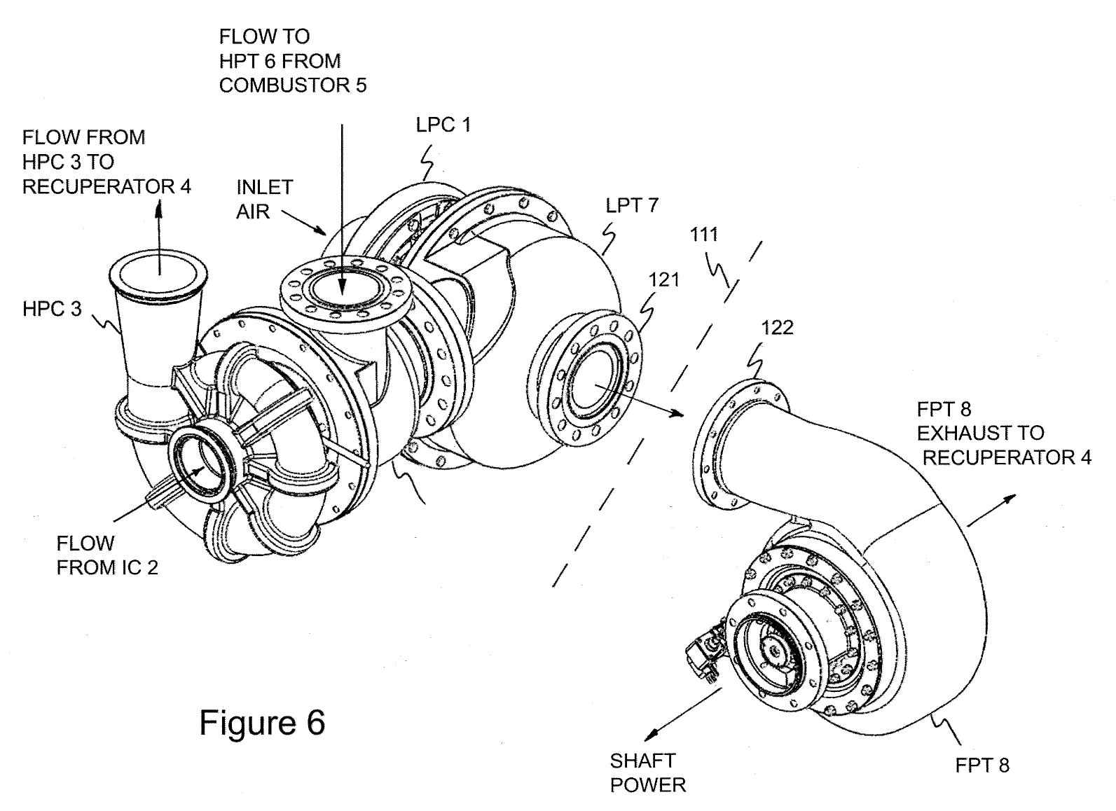

FIG. 6 is an exploded isometric view illustrating the points of connection within a gas turbine engine. This figure is the same as FIG. 5 except that the high pressure compressor 3 is rotated 180 degrees relative to high pressure turbine 6. A first connection point at location 111 between the low pressure turbine 7 outlet and free power turbine 8 input is shown disconnected at output flange 121 of low pressure turbine 7 and input flange 122 of free power turbine 8. A second connection point (not shown but the same as in FIG. 5) is between free power turbine 8 outlet and a duct leading to recuperator 4 inlet.

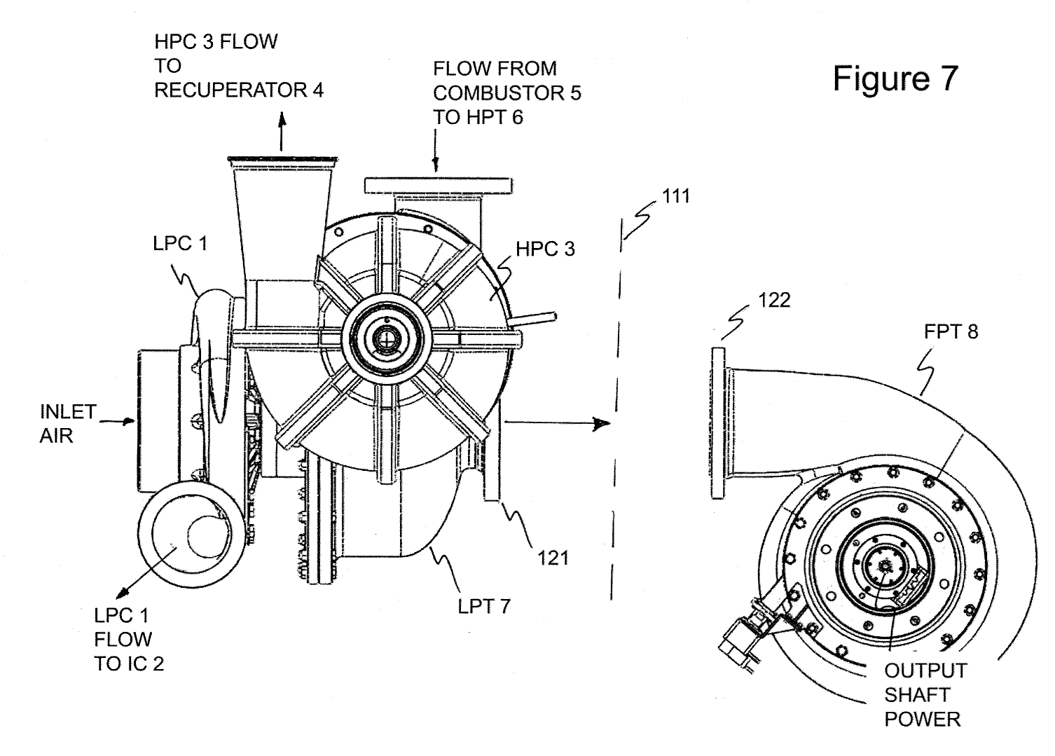

FIG. 7 is an exploded side view illustrating the points of connection within a gas turbine engine. The working fluid (air or, in some engine configurations, an air-fuel mixture) enters low pressure compressor 1 and the resulting compressed flow is sent to an intercooler (not shown in this figure but illustrated in Figure as component 2). Flow from the intercooler enters high pressure compressor 3 and the resulting further compressed flow is sent to the cold side of a recuperator (not shown in this figure but illustrated in FIG. 1 as component 4). Flow from a combustor (not shown as it is typically embedded within recuperator 4) enters high pressure turbine 6, is expanded and sent to low pressure turbine 7 where it is further expanded and delivered to free power turbine 8. In this engine configuration, free power turbine 8 provides the primary mechanical shaft power of the engine. The flow from free power turbine 8 is sent to the hot side of the recuperator (not shown in this figure but illustrated in FIG. 1 as component 4). According to the present invention, the connection points between the engine module and load module may be at location 111 between the low pressure turbine 7 outlet and free power turbine 8 input and at location 112 between free power turbine 8 outlet and a duct leading to recuperator 4 inlet. A first connection point at location 111 between the low pressure turbine 7 outlet and free power turbine 8 input is shown disconnected at output flange 121 of low pressure turbine 7 and input flange 122 of free power turbine 8. A second connection point at location 112 is between free power turbine 8 outlet and a duct leading to recuperator 4 inlet. As can be appreciated, the connection points between the engine module and load module may be at different locations, such as for example between the high pressure turbine outlet and the low pressure turbine inlet and between the free power turbine outlet and a duct leading to recuperator inlet.

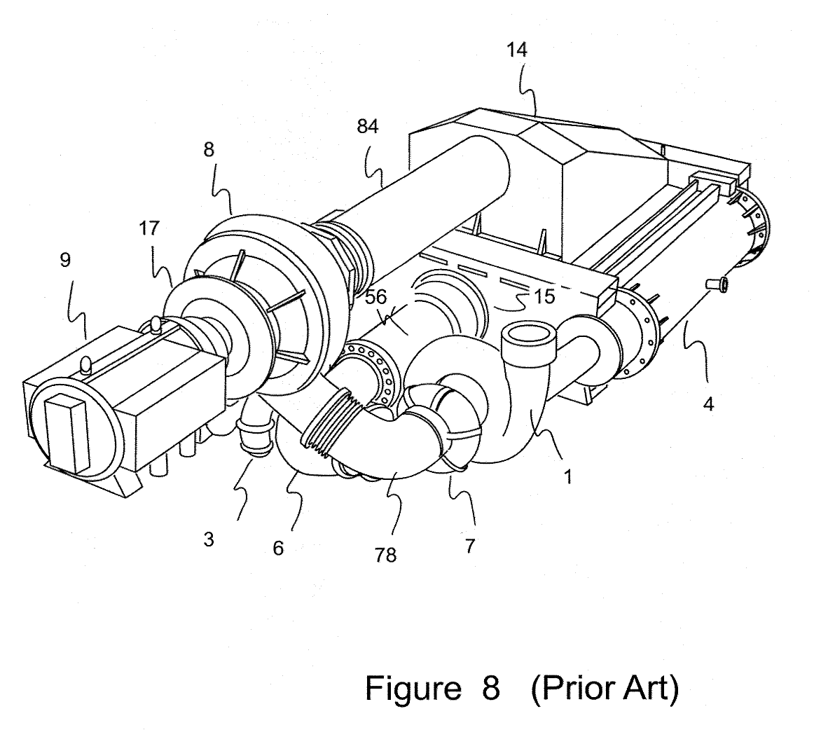

FIG. 8 is an isometric view of the points of connection between a vehicle engine module and its transmission module. This figure shows a load device 9, such as for example a high speed alternator, attached via a reducing gearbox 17 to the output shaft of a free power turbine 8. A cylindrical duct 84 delivers the exhaust from free power turbine 8 to the hot side of recuperator 4. Low pressure compressor 1 receives its inlet air via a duct (not shown) and sends compressed inlet flow to an intercooler (also not shown). The flow from the intercooler is sent to high pressure compressor 3 which is partially visible underneath free power turbine 8. As described previously, the compressed flow from high pressure compressor 3 is sent to the cold side of recuperator 4 and then to a combustor which is contained within a hot air pipe inside recuperator 4. The flow from combustor 5 (whose outlet end is just visible as the combustor is embedded inside recuperator 4 in this configuration) is delivered to high pressure turbine 6 via cylindrical duct 56. The flow from high pressure turbine 6 is directed through low pressure turbine 7. The expanded flow from low pressure turbine 7 is then delivered to free power turbine 8 via a cylindrical elbow 78. Recuperator 4 is a three hole recuperator such as described in U.S. patent application Ser. No. 12/115,219 filed May 5, 2008, entitled “Heat Exchanger with Pressure and Thermal Strain Management”, which is incorporated herein by reference. According to the present invention, the connection points between the engine module and load module may be at location 111 between the low pressure turbine 7 outlet and free power turbine 8 input and at location 112 between free power turbine 8 outlet and a duct leading to recuperator 4 inlet. In this vehicle engine configuration, connection point 112 may be anywhere along duct 78 which connects free power turbine 8 with low pressure turbine 7.

This engine has a relatively flat efficiency curve over wide operating range. It also has a multi-fuel capability with the ability to change fuels on the fly as described in U.S. patent application Ser. No. 13/090,104 entitled “Multi-Fuel Vehicle Strategy”, filed on Apr. 19, 2011 and which is incorporated herein by reference.

For example, in a large Class 8 truck application, the ability to close couple turbomachinery components can lead to the following benefits. Parts of the engine can be modular so components can be positioned throughout vehicle. The low aspect ratio and low frontal area of components such as the spools, intercooler and recuperator facilitates aerodynamic styling. The turbocharger-like components have the advantage of being familiar to mechanics who do maintenance on turbo-charged diesels. In a Class 8 truck chassis, the components can all be fitted between the main structural rails of the chassis so that the gas turbine engine occupies less space than a diesel engine of comparable power rating. This reduced size and installation flexibility facilitate retrofit and maintenance. This ability also permits the inclusion of an integrated APU on either or both of the low and high pressure spools such as described in U.S. patent application Ser. No. 13/175,564 filed Jul. 1, 2011, entitled “Improved Multi-spool Intercooled Recuperated Gas Turbine” which is incorporated herein by reference. This ability also enables use of direct drive or hybrid drive transmission options.

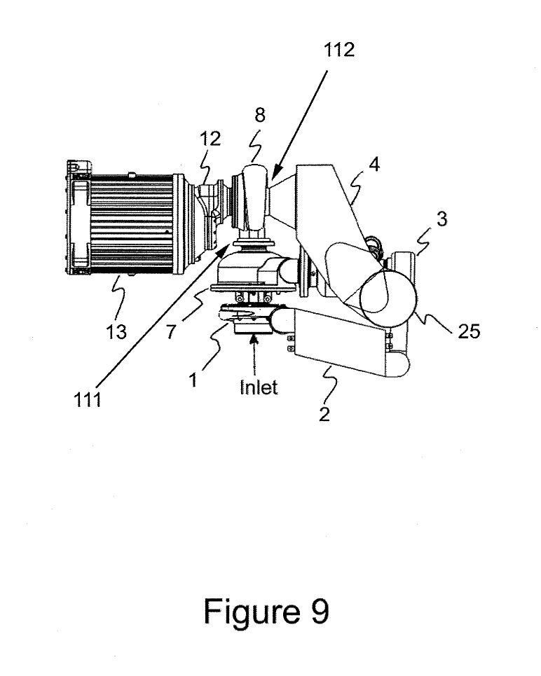

FIG. 9 is a plan view of a gas turbine engine with horizontal generator showing the points of connection between an engine module and its load module. This view shows air inlet to low pressure compressor 1, intercooler 2, low pressure turbine 7, high pressure compressor 3, recuperator 4, recuperator exhaust stack 25 and free power turbine 8. The output shaft of free power turbine 8 is connected to a reducing gear in gearbox 12 which, in turn, is connected to generator 13. According to the present invention, the connection points between the engine module and load module may be at location 111 between the low pressure turbine 7 outlet and free power turbine 8 input and at location 112 between free power turbine 8 outlet and a duct leading to recuperator 4 inlet.

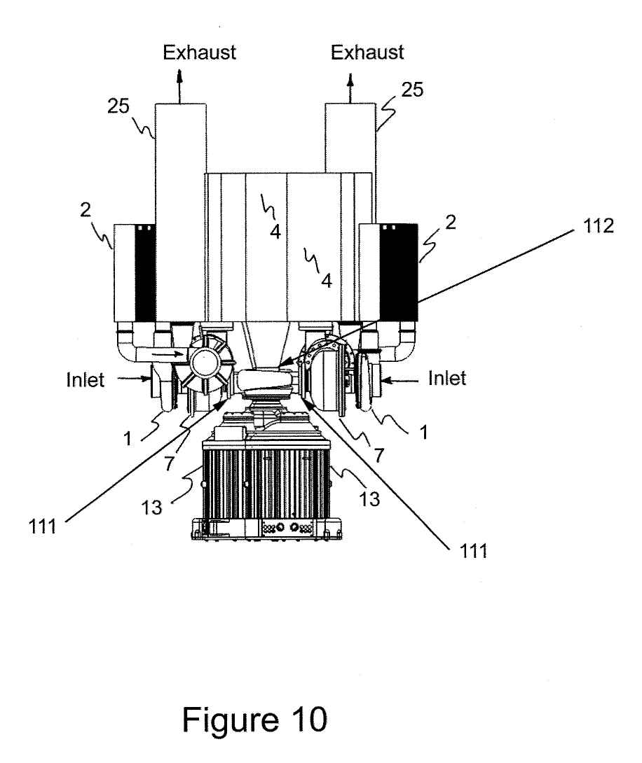

FIG. 10 is a front view of two nested gas turbine engines with vertical transmissions showing the visible points of connection between a dual engine module and its dual load module. This view shows air inlets to two low pressure compressors 1, two intercoolers 2, two low pressure turbines 7, two recuperators 4 and free power turbine 8. The two combustors are contained within the two recuperators 4 in their hot air pipes. This arrangement illustrates one embodiment of directly coupled turbomachinery to make a compact arrangement. The output shafts of the two free power turbines are connected to gearboxes which, in turn, are connected to two generators 13. According to the present invention, the connection points between the engine module and load module may be at locations 111 between the low pressure turbine 7 outlets and free power turbine 8 inputs and location 112 between free power turbine 8 outlets and ducts leading to recuperator 4 inlets (the second connection point between the second free power turbine outlet and the duct leading to the second recuperator is not visible in this view).

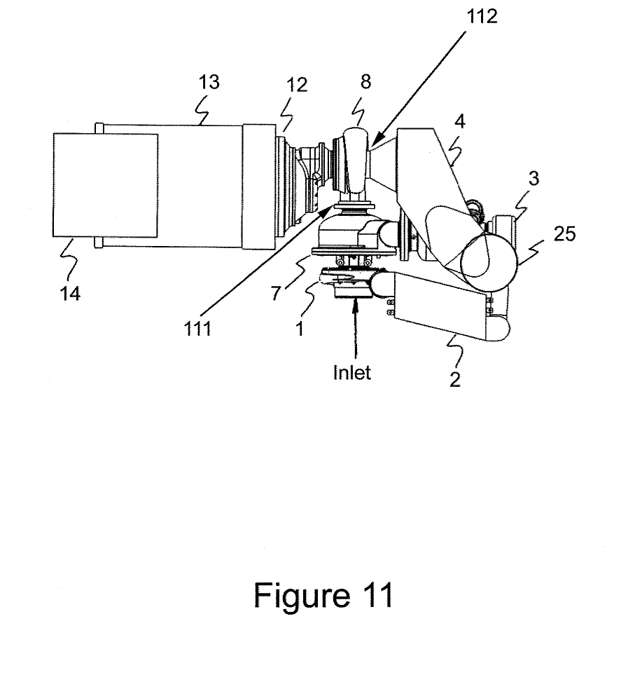

FIG. 11 is a plan view of a gas turbine engine with horizontal generator showing the points of connection between an engine module and its right-angle electrical generating module. This view shows air inlet to low pressure compressor 1, intercooler 2, low pressure turbine 7, high pressure compressor 3, recuperator 4, recuperator exhaust stack 25 and free power turbine 8. The output shaft of free power turbine 8 is connected to a reducing gear in gearbox 12 which, in turn, is connected to alternator 13. Also shown is its electronics control box 14. According to the present invention, the connection points between the engine module and load module may be at location 111 between the low pressure turbine 7 outlet and free power turbine 8 input and at location 112 between free power turbine 8 outlet and a duct leading to recuperator 4 inlet.

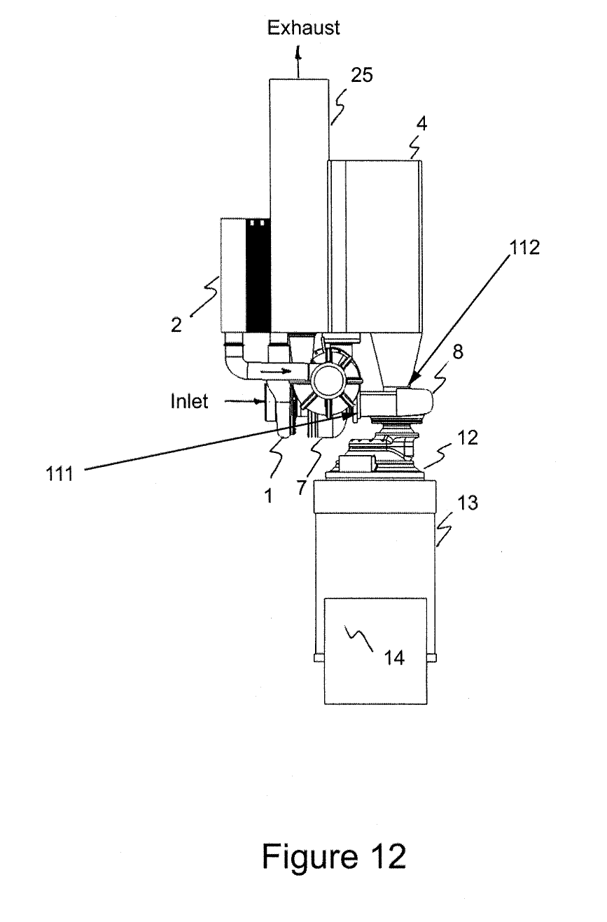

FIG. 12 is a front view of a gas turbine engine with vertical generator showing the points of connection between an engine module and its in-line electrical generating module. This view shows air inlet to low pressure compressor 1, intercooler 2, low pressure turbine 7, recuperator 4 and free power turbine 8. The combustor is contained within recuperator 4 a a hot air pipe. The output shaft of free power turbine 8 is connected to a reducing gear in gearbox 12 which, in turn, is connected to alternator 13. Also shown is its electronics control box 14. According to the present invention, the connection points between the engine module and load module may be at location 111 between the low pressure turbine 7 outlet and free power turbine 8 input and at location 112 between free power turbine 8 outlet and a duct leading to recuperator 4 inlet.

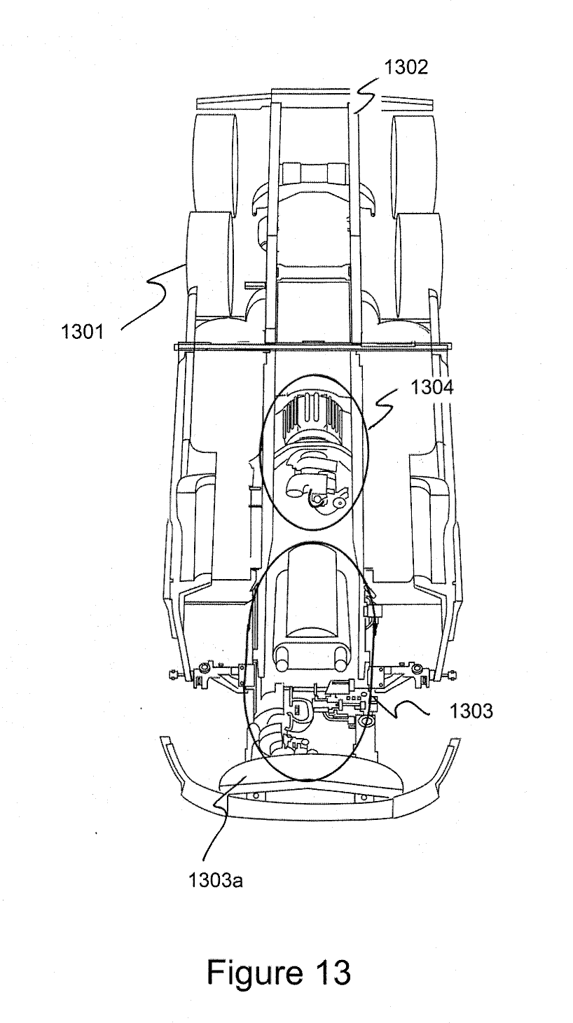

FIG. 13 is an isometric plan view of a gasifier module 1303 and transmission module 1304 mounted within in a truck frame 1302. This figure shows the free power turbine disconnected from the gasifier components but remaining attached to the transmission. The gasifier components 1303 are arranged in one of several possible arrangements within the main frame members of the truck cab chassis. The ducting between gasifier components is not shown in this view. The intercooler 1303a, which is a component in gasifier module 1303 is shown as part of the front bumper assembly. The load module (free power turbine and transmission) can be detached by disconnecting the duct between the free power turbine and the low pressure turbine and the duct between the free power turbine and the recuperator. As can be seen, the gasifier module and load module need not be coaxial. Thus the majority of engine components (the components of the gasifier module) need not be coaxial with the load module. In a vehicle application, the load module is typically a mechanical, electrical or hybrid transmission and the transmission can be aligned with the drive train without regard to the alignment or orientation of the gasifier module and its components.

Since the gasifier module need not be aligned or coaxial with the load module, the gasifier module components may be arranged to fit the available space and may be arranged at any orientation with respect to the load module.

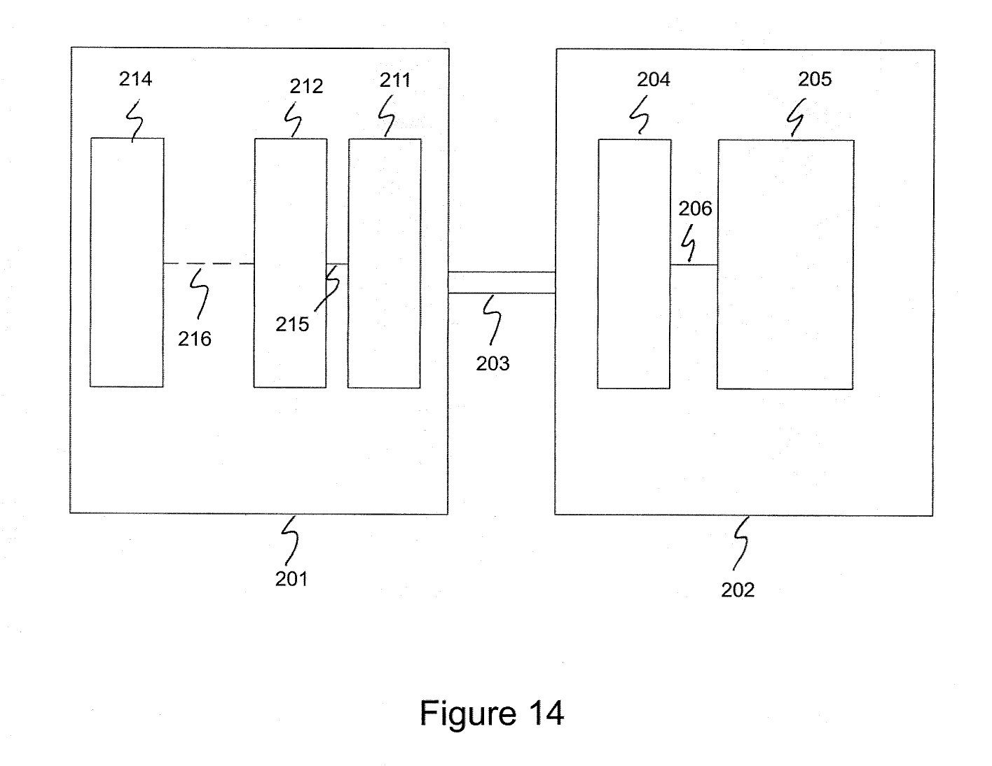

FIG. 14 is a block schematic illustrating the present invention. This figure summarizes the present invention, illustrating a gasifier module 201 connected to a load module 202 by ducting 203 (two schematic ducts are shown). The load module 202 is comprised of a free power turbine 204 mechanically connected to a load 205 by a mechanical coupling 206. The load may be, for example, a generator or a transmission. The gasifier or engine module 201 is comprised of several gasifier or engine components 211, 212, 214 etcetera which may be connected by fluid ducting or mechanical linkages 215, 216 etcetera. Examples of gasifier or engine components include but are not limited to compressor/turbine spools, combustors, reheaters, recuperators, intercoolers and the like. The key concept is that the gasifier or engine module 201 may be connected or disconnected from the load module 202 by connecting or disconnecting the two modules at fluid ducting interfaces 203. Either or both of the gasifier module 201 and load module 202 may or may not be skid mounted as required by the specific application.

### Axes Conventions

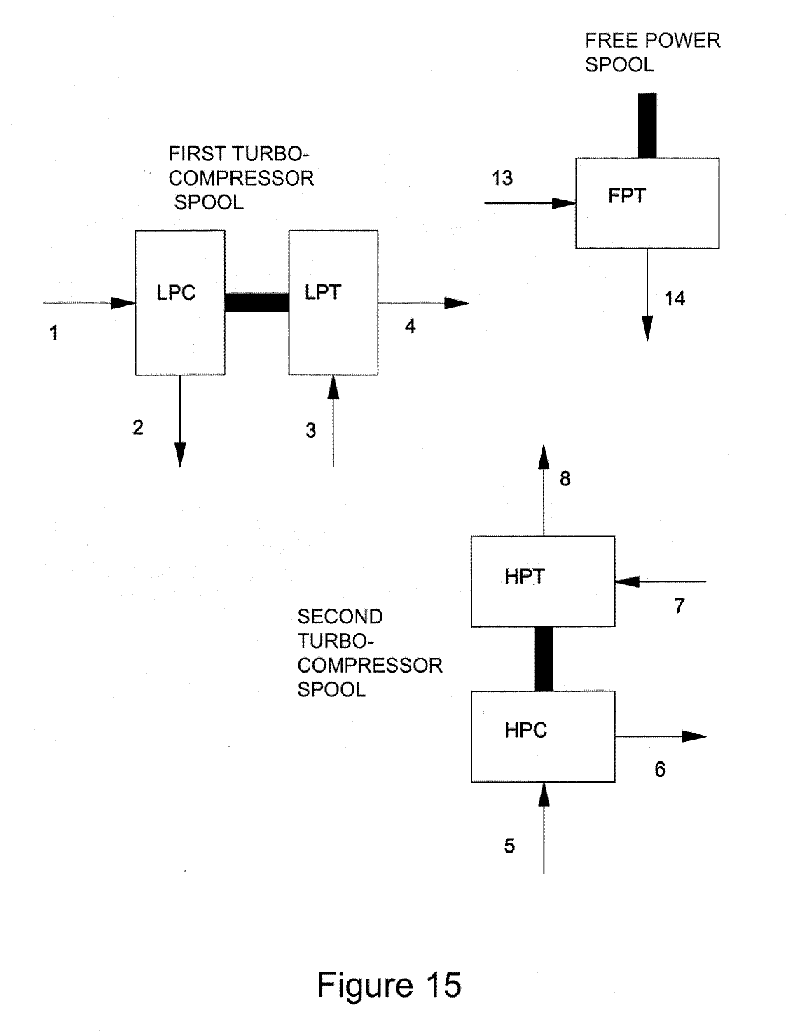

FIG. 15 shows centrifugal compressor and radial turbine axes conventions used herein. As used herein, transverse means “not parallel”. An axis may be the axis of rotation of the compressor rotor and turbine rotor which is commonly mounted on the same a shaft. Therefore the axis of rotation of a centrifugal compressor inlet is the same axis of rotation as its corresponding radial turbine outlet. An axis may also be the direction of the outlet flow of a centrifugal compressor or the direction of the inlet flow to a radial turbine. On any turbo-compressor spool, the axis of the outlet flow of a centrifugal compressor or the axis of the inlet flow to a radial turbine are orthogonal to the axis of rotation of the spool. Since these axes can be rotated independently, they can be at any angle in a plane which is always orthogonal to the axis of rotation. These axes may be parallel but in general they are transverse to each other but in the same plane.

In a multi-spool gas turbine engine using centrifugal compressors and radial turbines on a spool (called a turbo-compressor spool), the axes of rotation of adjacent spools are typically orthogonal, however they may be ± about 15 degrees from orthogonal to facilitate packaging. When the spools are within ± about 15 degrees from orthogonal, they are assumed to be “substantially orthogonal”.

For a first and second turbo-compressor spool, the following conventions are used:
the first axis is along the direction of flow into the compressor of the first turbo-compressor spool and is the axis of rotation of the first turbo-compressor spool
the second axis is along the direction of flow out of the compressor of the first turbo-compressor spool and is in the plane that is orthogonal to the axis of rotation of the first turbo-compressor spool
the third axis is along the direction of flow into the turbine of the first turbo-compressor spool and is in the plane that is orthogonal to the axis of rotation of the first turbo-compressor spool
the fourth axis is along the direction of flow out of the turbine of the first turbo-compressor spool and is the axis of rotation of the first turbo-compressor spool
the fifth axis is along the direction of flow into the compressor of the second turbo-compressor spool and is the axis of rotation of the second turbo-compressor spool
the sixth axis is along the direction of flow out of the compressor of the second turbo-compressor spool and is in the plane that is orthogonal to the axis of rotation of the second turbo-compressor spool
the seventh axis is along the direction of flow into the turbine of the second turbo-compressor spool and is in the plane that is orthogonal to the axis of rotation of the second turbo-compressor spool
the eighth axis is along the direction of flow out of the turbine of the second turbo-compressor spool and is the axis of rotation of the second turbo-compressor spool
the thirteenth axis is along the direction of flow into the free power turbine of the free power spool
the fourteenth axis is along the direction of flow out of the free power turbine of the free power spool and, along with the power output shaft of the free turbine, forms the axis of rotation of the free power spool

The ninth, tenth, eleventh and twelfth axes are reserved for a third turbo-compressor spool.

In general, the following relations pertain:
the first and fourth axes are the axis of rotation of the first turbo-compressor spool
the fifth and eighth axes are the axis of rotation of the second turbo-compressor spool
the first, second, fifth and sixth axes are compressor axes
the third, fourth, seventh and eighth axes are turbine axes
axes 1 and 4 are along the same axis and their flow is in the same direction
axes 5 and 8 are along the same axis and their flow is in the same direction
axes 2 and 3 are in the same plane and their axes are usually transverse but can be parallel
axes 5 and 8 are along the same axis and their axes are usually transverse but can be parallel

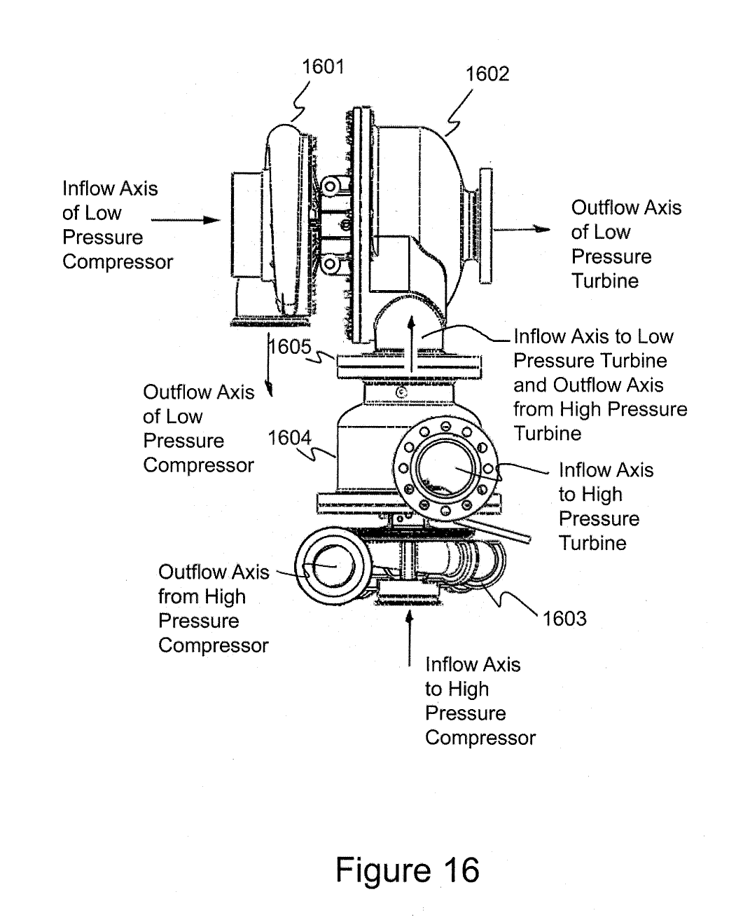

FIG. 16 is a plan view illustrating various gas turbine engine components of a two spool assembly illustrating some of the relationships among the various axes. The working fluid (air or, in some engine configurations, an air-fuel mixture) enters low pressure compressor 1601 and the resulting compressed flow is sent to an intercooler (not shown). Flow from the intercooler enters high pressure compressor 1603 and the resulting further compressed flow is sent to the cold side of a recuperator (not shown). Flow from a combustor (not shown as it is typically embedded within recuperator) enters high pressure turbine 1604 is expanded and sent to low pressure turbine 1602 where it is further expanded and delivered to a free power turbine (not shown). The outflow axis of low pressure compressor 1601 is shown exiting downward on the page. The outflow axis from the high pressure compressor 1603 is shown entering from the front of the page. The inflow axis of the high pressure turbine 1604 is also shown entering from the front of the page.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

A number of variations and modifications of the inventions can be used. As will be appreciated, it would be possible to provide for some features of the inventions without providing others.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter

What is claimed is:

1. An apparatus, comprising:
a gasifier module comprising at least one turbo-compressor spool and a combustor, the at least one turbo-compressor spool comprising a compressor in mechanical communication with a turbine;
a load module comprising a free power turbine and a load in mechanical communication with the free power turbine, and
ducting, wherein the gasifier and load modules are fluidly connected by the ducting and wherein at least one of the following is true (a) a flow axis of the combusted working fluid output of the gasifier is transverse to a flow axis of the combusted working fluid into the free power turbine, (b) the flow axis of the combusted working fluid output of the gasifier is transverse to an axis of rotation of the free power turbine, (c) the gasifier module is located remotely from the load module, and (d) an axis of rotation of the at least one turbo-compressor spool is transverse to an axis of rotation of the free power turbine, whereby a combusted working fluid output by the gasifier module drives the free power turbine, the free power turbine in turn providing rotary power to an output power shaft in mechanical communication with the load.

2. The apparatus of claim 1, wherein the gasifier module includes a recuperator, wherein combusted working fluid is output by the free power turbine, wherein the ducting includes first and second ducts, the first duct fluidly connects the turbine to the free power turbine, and wherein the second duct fluidly connects the free power turbine to the recuperator.

3. The apparatus of claim 1, wherein a connection interface between the gasifier and load modules is a flanged duct connection, wherein the at least one turbo-compressor spool comprises first and second turbo-compressor spools, each of the first and second turbo-compressor spools comprises a turbine mechanically engaged with a compressor by a shaft, and wherein the shafts of the first and second turbo-compressor spools are not aligned.

4. The apparatus of claim 2, wherein the first and second ducts comprise a bellows section and are at least one of detachable, rotatable, curved, substantially flexible and adjustable.

5. The apparatus of claim 1, wherein the at least one turbo-compressor spool comprises first and second turbo-compressor spools, the first turbo-compressor spool comprising a lower pressure compressor in mechanical communication with a lower pressure turbine and the second turbo-compressor spool comprising a higher pressure compressor in mechanical communication with a higher pressure turbine, the lower pressure compressor being in fluid communication with an intercooler and wherein the intercooler is in fluid communication with the higher pressure compressor, wherein the gasifier module comprises a combustor and a recuperator.

6. The apparatus of claim 5, wherein the turbo-compressor spools of the gasifier module are co-located while the components of the load module are located remotely from the gasifier module.

7. The apparatus of claim 1, wherein the gasifier module is located in at least one of a front portion of a vehicle and a rear portion of the vehicle and the load module is located in the other of the at least one of a front portion of a vehicle and a rear portion of the vehicle.

8. The apparatus of claim 7, wherein the ducting is comprised of a bellows section and is at least one of detachable, rotatable, curved, substantially flexible and adjustable.

9. A gasifier module, comprising:
a combustor;
a recuperator; and
first and second turbo-compressor spools, the first turbo-compressor spool comprising a lower pressure compressor in mechanical communication with a lower pressure turbine and the second turbo-compressor spool comprising a higher pressure compressor in mechanical communication with a higher pressure turbine, the higher pressure compressor being in fluid communication with the recuperator and combustor and the combustor being in fluid communication with higher pressure turbine;
wherein the lower pressure turbine is configured to be fluidly connected to a free power turbine by a duct and a flow axis of the combusted working fluid output of the gasifier is transverse to a shaft connecting the free power turbine to a gearbox, the gearbox in turn being engaged with a load;
whereby an inlet gas is pressurized by the lower pressure compressor to form a lower pressure working fluid, the lower pressure working fluid is pressurized by the higher pressure compressor to form a higher pressure working fluid, the higher pressure working fluid and a fuel are combusted by the combustor to form a heated pressurized working fluid, the heated pressurized working fluid passing through the higher pressure and lower pressure turbines to drive, respectively, the higher and lower pressure turbines, and the free power turbine to drive a load mechanically connected to the free power turbine.

10. The gasifier module of claim 9, wherein the combustor, recuperator and first and second turbo-compressor spools are co-located, wherein the first and second turbo-compressor spools each comprise a turbine mechanically engaged with a compressor by a shaft, and wherein the shafts of the first and second turbo-compressor spools are not aligned.

11. The gasifier module of claim 9, wherein the ducting is comprised of a bellows section and is at least one of detachable, rotatable, curved, substantially flexible and adjustable, wherein, after fluidly connecting the lower pressure turbine to the free power turbine, the free power turbine is located remotely from the gasifier module, and wherein a flow axis of the combusted working fluid output of the gasifier is transverse to an axis of rotation of the free power turbine.

12. A load module, comprising:
a free power turbine; and
a load mechanically linked to the free power turbine to receive mechanical energy from the free power turbine,
wherein the free power turbine is configured to be fluidly connected to a lower pressure turbine of a gasifier module by a duct and a flow axis of the combusted working fluid output of the gasifier is transverse to an axis of at least one of a transmission and an electrical generator.

13. The load module of claim 12, wherein the gasifier module comprises:
a combustor; and
first and second turbo-compressor spools, the first turbo-compressor spool comprising a lower pressure compressor in mechanical communication with the lower pressure turbine and the second turbo-compressor spool comprising a higher pressure compressor in mechanical communication with a higher pressure turbine, the higher pressure compressor being in fluid communication with the recuperator and combustor and the combustor being in fluid communication with the higher pressure turbine; whereby an inlet gas is pressurized by the lower pressure compressor to form a lower pressure working fluid, the lower pressure working fluid is pressurized by the higher pressure compressor to form a higher pressure working fluid, the higher pressure working fluid and a fuel are combusted by the combustor to form a heated working fluid, the heated working fluid passing through the higher pressure and lower pressure turbines to drive, respectively, the higher and lower turbines, and the free power turbine to drive the load.

14. The load module of claim 12, wherein the recuperator, combustor, and first and second turbo-compressor spools are co-located, wherein each of the first and second turbo-compressor spools comprises a turbine mechanically engaged with a compressor by a shaft, and wherein the shafts of the first and second turbo-compressor spools are not aligned.

15. The gasifier module of claim 9, wherein the ducting is comprised of a bellows section and is at least one of detachable, rotatable, curved, substantially flexible and adjustable, wherein, after fluidly connecting the lower pressure turbine to the free power turbine, the free power turbine is located remotely from the gasifier module, and wherein a flow axis of the combusted working fluid output of the gasifier is transverse to an axis of rotation of the free power turbine.

16. A method, comprising:
providing a gasifier module, the gasifier module comprising at least one turbo-compressor spool and a combustor, the at least one turbo-compressor spool comprising a compressor in mechanical communication with a turbine;
providing a load module comprising a free power turbine and a load in mechanical communication with the free power turbine, and
connecting ducting to, or disconnecting ducting from at least one of the gasifier and load modules, the ducting fluidly connecting the gasifier and load modules, wherein, in the absence of the ducting, substantially no energy is transferred from the gasifier module to the load module.

17. The method of claim 16, wherein the gasifier and load modules are not interconnected by a direct or indirect mechanical link.

18. The method of claim 16, wherein the gasifier module comprises a recuperator and wherein the ducting comprises first and second ducts, the first duct extending from the turbine to the free power turbine and the second duct extending from the free power turbine to the recuperator.

19. The method of claim 18, wherein no other ducting fluidly connects the load and gasifier modules.

20. The method of claim 16, wherein at least about 85% of the energy transferred from the gasifier module to the load module is in the form carried by a combusted working fluid exchanged between the gasifier and load modules.
